(19) United States
(12) Patent Application Publication
(10) Pub. No.: US 2011/0304874 A1
(43) Pub. Date: Dec. 15, 2011

(54) SYSTEM AND METHOD FOR OPERATING A PERIPHERAL DEVICE FROM A PROGRAM USING INTERFACE SUITABLE FOR OPERATION OF ANOTHER TYPE OF PERIPHERAL DEVICE

(76) Inventor: Dov AHARONSON, Herzelia (IL)

(21) Appl. No.: 12/814,887

(22) Filed: Jun. 14, 2010

(51) Int. Cl. G06F 3/12; H04N 1/04

(52) U.S. Cl. 358/1.15; 358/474

(57) ABSTRACT

A system and method for operating a peripheral device from a computer application or program, by inserting commands for an operation of the device into commands of an API that is supported by the computer application and is suitable for operation of another and different type of peripheral. The inserted commands are recognized and presented to the device.

### FIELD OF THE INVENTION

The present invention relates to operation of computer peripheral devices such as document scanners from within a computer program that lacks commands needed to operate such device or have such commands but operates the device through interface for a different type of device which requires different type of commands.

### BACKGROUND OF THE INVENTION

Certain computer programs may include operation commands and interfaces for a limited number or range of peripheral devices, such as storage devices, network, displays, printers, fax machines or modems. Other kinds of devices such as document scanners may not be operable from the commands and interfaces that are included in such programs. For example, while a spreadsheet or word processing program may include a file storage input/output or print function that allows a user to activate a printer and even set the number of copies to be printed and choose portrait or landscape printing, such word processor program may not typically include functions to allow a user to activate a scanner, select parameters for the scanner, issue a command to scan a page in the scanner and import the scanned document into the word processor, spread sheet or other program from which the command was issued.

Referring to FIG. 1, a schematic diagram of software and devices in the prior art, a software application 90, may be associated with an application device program interface 92. Interface 92 may include various parameter 98 selections, settings and feature 97 selections from among which a user of application 90 may chose to operate a device 96. Interface 92 may communicate with a driver 94 associated with operating system 95 for the execution of parameters 98 and features 97 that were chosen by a user to execute one of the functions of device 96. Such commands may include a designation of one or more parameters 98 for one or more features 97 of device 96. In some cases, for example in the TWAIN scanner interface, there is an additional layer of functional interface library between the user application 90 and the device driver 94, this layer handles the specific functionality of a device while the device driver 94 handles the more basic communication functions with the device.

### SUMMARY OF THE INVENTION

In some embodiments, a method of operating a first device from a program that lacks an interface for the first device, or have such interface but it is not being used for this case, may include issuing a command from an interface of the program, where such interface is suitable to operate a second device but not suitable to operate the first device, embedding in the command parameters to operate the first device, extracting from the command the parameter necessary to operate the first device, and applying the extracted parameter to an operation of the first device.

In some embodiments the method may include accepting commands from a user of the program for an operation of the first device.

In some embodiments the method may include comparing the embedded commands from a user to a pre-defined list of commands that are acceptable for operation of the first device, and correcting commands that do not comply with the list of acceptable commands for a particular device.

In some embodiments the method may include selecting command parameters required for an operation of the first device and inserting such required parameters into the embedded commands.

In some embodiments the method may include querying the first device for a parameter suitable for operation of the first device, and storing such parameter in a file path associated with the first device.

In some embodiments the first device may include a scanner, the second device may include a hard drive and the command may include a file path relating to the hard drive. The process of embedding may include embedding an operational parameter for the scanner in the file path, and the process of applying the command may includes applying the operational parameter to a scan of a document by the scanner.

In some embodiments, the scanner may be represented by an entry in a file path of the hard drive, and the method may include selecting the file path from a function within the program.

In some embodiments the method may include detecting an inconsistency between a first entry in the file path and a second entry in the file path.

In some embodiments the method may include applying the second entry as an operational parameter for the scan.

In some embodiments detecting the inconsistency may include detecting that the first entry and the second entry represent parameters of a same feature of the scanner.

In some embodiments the method may include storing a default parameter for an operation of the first device in the command.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic diagram of a computer associated with computer peripheral devices in accordance with the prior art;

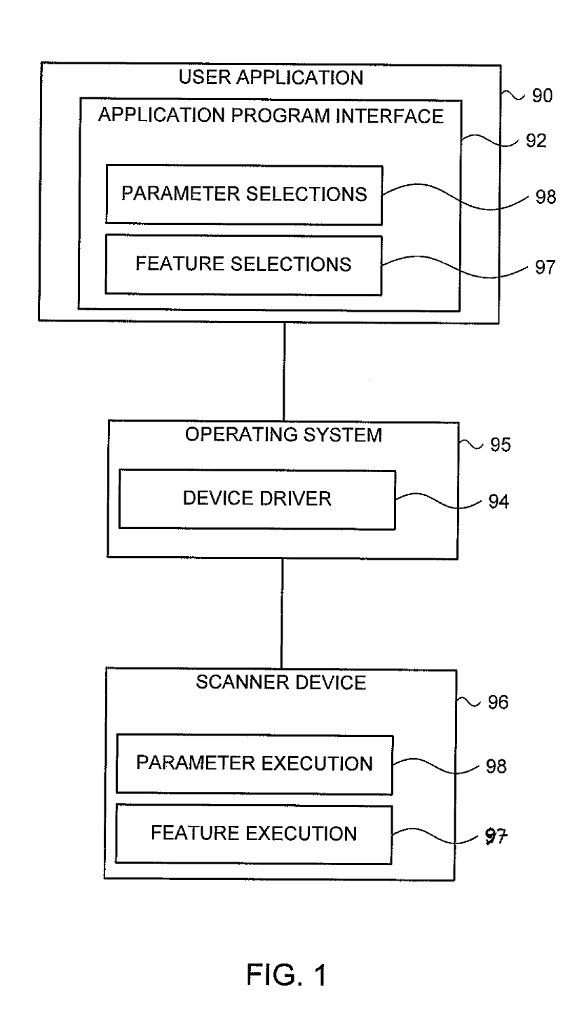

FIG. 2 is a schematic diagram of a computer associated with a computer peripheral device in accordance with an embodiment of the invention;

FIG. 3 is a block diagram of software modules that may be executed by a processor to perform a command or execute a function in accordance with an embodiment of the invention; and

FIG. 4 is a flow diagram of a method, in accordance with an embodiment of the invention.

### DETAILED DESCRIPTION OF THE PREFERRED EMBODIMENTS

In the following description, various embodiments of the invention will be described. For purposes of explanation, specific examples are set forth in order to provide a thorough understanding of at least one embodiment of the invention. However, it will also be apparent to one skilled in the art that other embodiments of the invention are not limited to the examples described herein. Furthermore, well-known features may be omitted or simplified in order not to obscure embodiments of the invention described herein.

Unless specifically stated otherwise, as apparent from the following discussions, it is appreciated that throughout the specification, discussions utilizing terms such as “selecting,” “evaluating,”, “detecting”, “processing,” “computing,” “calculating,” “associating,” “determining,” “designating,” “allocating” or the like, refer to the actions and/or processes of a computer, computer processor or computing system, or similar electronic computing device, that may manipulate, calculate, compare and/or transform data represented as physical, such as electronic, quantities within the computing system's registers and/or memories into other data similarly represented as physical quantities within the computing system's memories, registers or other such information storage, transmission or display devices.

As used in this application, the term ‘device’, may, in addition to its regular usage, mean a hardware or software component of a computer that may interact with one or more operating systems or drivers of a computer and perform a function upon a command of the computer. For example, a device may include or comprise a hard drive, printer, fax machine, document scanner, Structured Query Language (SQL) engine, a loudspeaker system, joystick or other component that may be operated from a computer that may be associated with the device.

As used in this application the term ‘storage device’ may include a device to save or store data in an electronic format. A user application may communicate with the storage device through an application program interface (API) that lets the user application use, control and issue input/output commands to the storage device and to check, manage and read or write data to the storage device. Storage device may include for example hard-drive, memory-stick, DVD or CD ROM, memory card etc. or any of such devices embedded within another type of device for example a combined multi function storage and scanner device.

As used in this application, and in addition to its regular meaning, an ‘application’ or ‘user application’ may include a program (e.g., a set of computer-executable instructions or commands which are typically stored in a memory or other storage and, when executed by a processor, perform the functions of the application) or package performing one or more functions in response to high level commands. Examples of a user application may include a word processor, electronic spread sheet, data base manager, scheduler, calendar, email package, or other applications with user activated or automated processes to interact with a computer and its peripherals, such as printers, scanners or specific functional capabilities such as database management or, search engines for performing certain functions or tasks.

As used in this application, the term ‘interface’ may mean, in addition to its regular usage, one or more in a series of commands that may include protocols or API's that may regulate or control a communication between a user application and one or more devices and their relevant device drivers or device control libraries. Examples of interfaces may include TWAIN, ISIS, WIA as may be used as part of the interface of an application with documents scanners, or SQL, ODBC as may serve as an interface between user application using a query language and a data base. An interface may include a set of codes or instructions that when executed by a processor perform a function, or relay, transmit or convert a set of instructions to a device, commanding it to perform a function or implement a feature or parameter of a device.

As used in this application, the term ‘feature’ may mean, in addition to its regular usage, a category of capabilities that may be applied to an operation of a device. For example, features of a scanner may include color scanning or monochrome (black and white) scanning, grey scale range, bits per sample pixel, resolution, page size, compression, data formatting (.pdf, .tif, etc), color printing, filter activation, function activation (such as for example optical character recognition, fax functions, or other functions) and number of pages to be scanned. Other features may be available for scanners as well as other devices.

As used in this application, the term ‘parameter’ may mean, in addition to its regular usage, one or more settings that may be activated in the implementation of a feature of the device. For example, parameters of a document scanning device may include a setting of the color feature at any of for example 1, 8, 16, 24, 32, or 48 bits per pixel sample. A parameter setting for resolution may be 100, 300, 600, 1200 dots per inch or others. Some devices may have required parameters that must be set for a performance by the device of a function, as well as optional parameters that may assume a default setting if no other selection is made.

The processes and functions presented herein are not inherently related to any particular computer, network, device or other apparatus. Embodiments of the invention described herein are not described with reference to any particular programming language, machine code, etc. It will be appreciated that a variety of programming languages, network systems, protocols or hardware configurations may be used to implement the teachings of the embodiments of the invention as described herein. In some embodiments, one or more methods of embodiments of the invention may be stored on an article such as a memory device, where such instructions, upon execution by a processor, result in a method of an embodiment of the invention. For example, drivers, user applications, API's and other software modules or components may include a series of codes or instructions that when executed by a processor perform a function or provide a command to perform a function.

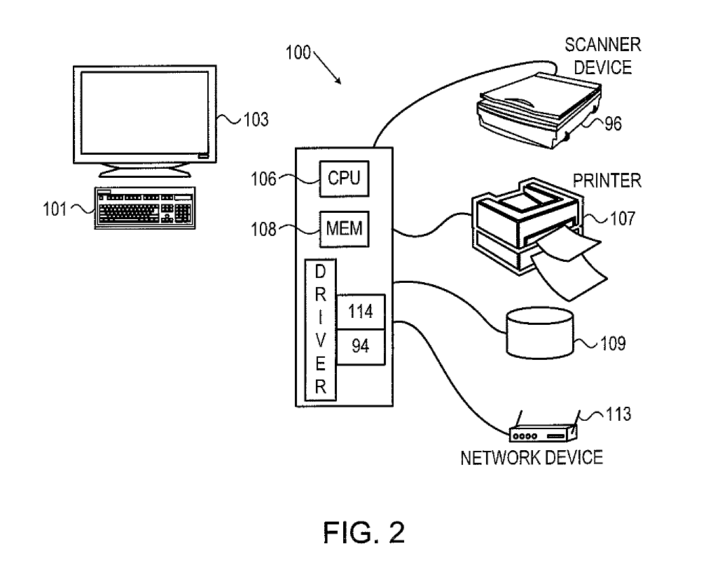

Reference is made to FIG. 2, a schematic diagram of a computer system associated with a computer peripheral device in accordance with an embodiment of the invention. A system 100 may include a computer 104 having one or more processors such as a CPU 106, a memory 108 such as random access memory, mass data storage device 109, such as a hard drive, a display or screen 103, and an input device such a keyboard 101. Computer 104 may be associated with or operatively connected to one or more devices 102 such as a scanner 96, printer 107, networked devices 113 or other devices.

Memory 108 or another data storage device may include or be associated with one or more drivers such as driver 94 that may be used with device 96, and driver 114 that may typically be used with storage device 109. A driver may be or include a set of computer-executable instructions or commands which when executed by a processor, help to communicate with or control a specific device

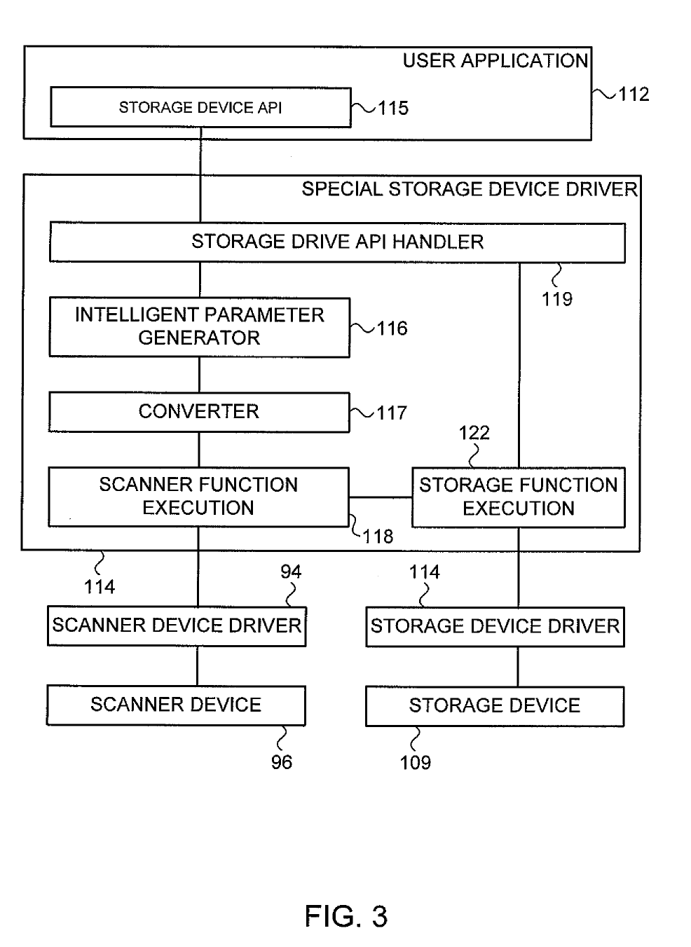

Reference is made to FIG. 3, a schematic diagram of software modules that may be included in one or more memories associated with a system, in accordance with an embodiment of the invention. Memory 108 or storage device 109 may include instructions that make up one or more applications such as user application 112. User application 112 may be designed or intended to operate with storage device API 115 to interface with storage device 109 or another input/output device that may store, retrieve or otherwise manipulate stored data. User application 112 may or may not include an API for operating a device such as device 96, and may lack or not include a possibility of selecting features 97 or parameters 98 or other actions that are generally used in operation of device 96. Instead, in an embodiment of the invention, computer 104 may operate device 96 from user application 112, indirectly, using special storage device driver 114 to access driver 94 where such driver 114 may redirect and interpret storage device commands into commands and APIs for driver 94.

Application 112 may typically interface with storage device 109 by way of for example a file path and I/O storage device API 115 that may designate, define and locate data storage areas such as folders and files that are stored for example on storage device 109, and that may instruct the storage or retrieval of data that may be created or used by application 112, to and from such designated files or folders on the basis of the addresses assigned in storage device API 115. Other interfaces of application 112 with other devices are possible.

User application 112 may include activation functions or parameter selection choices for storage device 109, but may lack activation functions or parameter selection options for device 96, such as for example a scanner, or may have such interface for device 96 but for any reason decide not to use it, since operation of device 96 may require a specific or dedicated API such as a scanner device API for device 96, such as WIA or ISIS or TWAIN. Other APIs may be required for other devices and such other APIs may likewise be unavailable in many user applications 112, such as for example APIs to access or operate databases or search engines.

In operation, a user may employ API 115 that is known to, compatible with and supported by user application 112, and that is typically suitable for operation of for example storage device 109, for operation of a device 96 such as a scanner, even though such API 115 or user application 112 would not usually be compatible with, equipped or suitable for operating or issuing commands to device 96. User application 112 may thereby activate, operate and select features 97 and parameters 98 for device 96 from within application 112 regardless of the absence or lack in such application 112 of capacity to select features 97 and parameters 98 for device 96.

In some embodiments, driver 114 that typically accepts input from an application 112 and sends appropriate output to, or receives input from the application to storage device 109 may include other modules and functionalities. The storage device driver 114 in may be a special storage device driver 114 that instead or in addition to the typical functionality, may also include handler 119, converter 117, parameter generator 116, and function execution module 118, which, when executed by a processor, may convert or translate requests or commands made by way of an API 115 to a storage device 109, into requests or commands to be made to a device 96 such as a scanner device which is not generally responsive to API 115.

Handler 119 may receive the API storage device commands from user application 112 and direct them to the proper handling module. Handler 119 may also return data back to user application 112 in case device 96 sends data back or interrupts user application 112.

Parameter generator 116 may analyze commands or other resources such as earlier commands, command statistics, default parameters settings saved on some storage locations, and may interrogate device 96. Based on the input and collected information, parameter generator 116 may generate parameters for device 96.

Function execution module 118 may collect additional required information for operation of device 96 and set such information as a set of parameters and functions for device 96 by way of handler 119 and parameter generator 116. Module 118 may generate the commands for device 96 according to a scanner API, and may deliver such commands to scanner driver 94. In some embodiments, driver 94 may be embedded as part of the driver 114 or as an external stand-alone driver

Converter 117 may convert API commands from handler 119, and from the output of the parameter generator 116, into commands for device 96 and its device driver 94.

In some embodiments, commands for device 96 may be issued from API 115 by embedding such commands or parameters in for example a registry or file path that is recognized or formatted to comply with API 115. Handler 119 that may be for example stored within memory 108, may detect the presence of commands or parameters 98 that may operate device 96 that are found in a registry, file path or in the contents of a file itself that may be pointed to by such file path, and may apply such parameters 98 to an operation of device 96 for example by using parameter generator 116 to analyze the potential sources and data of such parameters to generate a complete verified set of parameters, using converter 117 to convert the commands from API 115 and resulting parameters from generator 116 into new API commands suitable for device 96 and its device driver 94 and use function execution module 118 to communicate with device 96 through its driver 94.

In some embodiments, operating system 95 may include driver 94 which may directly drive device 96 and may include special storage device driver 114 which includes or is associated with handler 119 and converter 117 that may convert commands issued to a storage device into commands that are to be executed by device 96. Converter 117 may also be associated with function execution module 118, which together may communicate with storage device 109 and also accept user input commands from user application 112, and process such commands by way of parameter generator 116 and converter 117 and function execution module 118 into commands that may operate features 97 and parameters 98 of device 96.

For example, special storage device driver 114 may have been designated to be represented as drive q:, and may include for example sub-folders and file path—color300/A4/600dpi.pdf. A user who may be using for example a word processor or other application 112 may select for example a file <open> function and then may select the q: drive and the aforementioned path to be opened. Such file path, which is recognized by application 112, will be directed to the device driver of drive q:, special storage device driver 114 which includes handler 119, generator 116, converter 117 and function execution module 118. The user application file path may be processed by handler 119 and presented to parameter generator 116 that may be stored in for example memory 108 and that may recognize the designation of the device 96 that is represented in the file path, and may detect the various parameters 98 that are included in such path. Parameter generator 116 may transmit one or more signals and/or commands to converter 117 which may convert the data from handler 119 and the generator 116 into scanner device API commands and transfer it to a function execution module 118 stored in memory 108 that may activate device 96 through driver 94 to perform a function using the parameter 98 that was included in the path. In this example, selecting the path q:/color300/A4/600dpi.pdf from a file <open> function in the MicrosoftWord™ program is a standard API command that is included in many applications under the Windows™ operating system to read/write files. In this case, the function may activate the device 96 to for example scan an A4 sized document in color with a resolution of 600 dpi, and save the scanned image in a .pdf format. Such commands may be directed to device 96 even though the Microsoft Word program or some other user application 112 does not include an API for issuing commands to, or is not equipped with an interface for, device 96.

In some embodiments, parameter generator 116 may perform more than translation into a command or parameter 98 that is included in a file path, in that it may evaluate the consistency of one or more parameters 98 with other parameters 98 that may have been presented to it, and it may fill in or add missing parameters 98 that may be needed for the operation of device 96. For example, if a file path delivered to parameter generator 116 includes q:/color300/A4/600dpi/1800dpi.pdf, parameter generator 116 may detect that the 600 dpi parameter is inconsistent with the 1800 dpi parameter in such file path. If an inconsistency is detected, parameter generator 116 or some other module may determine for example that the parameter 98 that appears last or latest in the file path is the parameter that is to be used, relying on the assumption that the earlier-appearing parameter 98 was part of a default setting that is to be overridden by a more particular setting that appears later in the file path. Alternatively, parameter generator 116 may select the parameter 98 that appears first in the path, assuming that the first parameter represents a capability of device 96 and the second parameter's appearance represents the user's preferences that may conflict with such capabilities of device 96. In addition, system 100 may try to resolve missing parameters 98 by employing parameter values used before by the user or by getting such missing parameters from the computer registry or other storage files containing such defaults or operation instructions. In some embodiments, system 100 may present a query to the user asking the user to specify which parameter 98 is to be implemented or try to search the Internet or local network for the device specifications and most suitable parameters.

In some embodiments, parameter generator 116 may employ a natural language analysis that may allow a user to input or present one or many possible words or descriptions of the settings or parameters 98 to be used for activation and control of device 96. A natural language algorithm may interpret the user's instructions, select the appropriate parameters 98 and present the parameters 98 to the converter 117 and function execution module 118 which may generate the proper instructions to device 96 through its device driver 94.

In a process for installation of device 96 on operating system 95, or at some other time, the installation process may generate one or more device interfaces or libraries designating device 96 as a scanner device, and may also create special storage device driver 114 that includes handler 119, parameter generator 116, converter 117 and function execution module 118. Further, API 115 may designate such a requested special drive path for device 96 and assign to it the driver 114. In an embodiment, a letter may be assigned as a root storage device representing driver 114 with its components handles 119, parameter generator 116, converter 117 and function execution module 118 with optional sub folders pre-assigned to represent specific operation modes or parameters 98 of the device 96. For example, a root letter such as q: may represent special storage device driver 114 while q:\600dpiA4 or some other pre-assigned subfolder may represent an API for accessing device 96 to scan in 600 dpi and A4 size documents. In one embodiment, the installation may generate more than one root device such as q: for scanning 600 dpi, and f: for scanning 1200 dpi, etc. In other embodiments, in addition to the above options, an installation process or later process of the user or automated process may attach additional parameters 98 or features 97 to specific paths by for example altering a path text or by attaching such additional information to a specific path for example by setting special settings on the operating system registry or saving special definition files containing such additional information on storage device 109 or in memory 108. In some embodiments, such files may be viewed by or displayed to the user as files under the path of a relevant device folder. Function execution module 118 or parameter generator 116 may query device 96, or local computer 104 resources such as a system registry, its own local files or even search external resources such as the Internet or intranet to receive a listing of features 97 and parameters 98 that may be associated with each of such features 97 of device 96. Other definitions, capabilities and characteristics may also be requested and obtained from device 96 or from local resources on computer 104 such as the registry or from external resources such as Internet or intranet, and may be stored in memory 108 or elsewhere, and associated with the storage device 109 that was created to represent device 96. In some embodiments, a process of retrieving features 97, parameters 98, capabilities or other characteristics of device 96 may include a search over a network such as the Internet for a collection of capabilities. In some embodiments, a user may be prompted to select from among such capabilities or parameters 98, one or more default parameters 98 that are, in the absence of other selection by a user or application 112, to be presented to device 96 when device 96 is activated.

In some embodiments, parameter generator 116, converter 117, function execution module 118, and handler 119, may be included, connected to or added to a typical storage device driver to create special storage device driver 114 which enables transformation of commands suitable for storage device 109 into commands suitable to operate scanner device 96. The inclusion in or connection of parameter generator 116, converter 117, function execution module 118, handler 119, with storage device driver 114 allows commands to be input by a user through the user application 112 as if they were commands to storage device 109, and allows the user application to relate to such commands as if they were directed to storage device 109. In an embodiment of the invention, such commands are handled by parameter generator 116, converter 117, function execution module 118, handler 119, and are converted into commands that are compatible by device 96. In some embodiments, associating a drive with function execution module 118 or parameter generator 116 may associate the designated drive with one or both of function execution module 118 or parameter generator 116, so that further calls of paths that include the designated drive will call up function execution module 118 or parameter generator 116. In some embodiments, a drive such as memory 108, may include one or more virtual drives that have been segmented or partitioned from one or more physical memory devices.

In some embodiments, one, some or all of the collected parameters 98 may be assembled into possible file paths under the drive that had been designated to represent device 96. For example, if device 96 is represented by drive q:, and a path for activation and operation of device 96 begins with color300, a system in an embodiment of the invention may create, or offer to a user an option to create a series of file paths, where one such path is q:/color300/A4/300dpi, and another path is q:/color300/A4/600dpi. A user may then be able to select one of such paths from a display of for example Windows Explorer™ for the operation of the device. In some embodiments, some or all of the possible capabilities that may be selected by the user may appear in a drop down screen or other graphical interface of for example Windows Explorer that allows a user to make a selection. The selected parameter 98 may then be added by the system into a file path that may be presented to a user for selection. In some embodiments, one or more of such capabilities and parameters 98 as well as an association of the designated drive with the device 96 may be saved in a system registry or in an initialization (.ini) file.

If API 115 permits a drive to be designated by a name other than a letter, a descriptive name that includes embedded parameters 98, such as ‘color300A4’ may be assigned as a designation of a drive. When as user calls or clicks on the drive (e.g., using a pointing device to move a cursor over a screen representation of the drive), parameter generator 116 may present the parameters 98 appearing in the name of the drive to function execution module 118 to activate device 96 using the color 300 and A4 as operational parameters.

In some embodiments, it may not be necessary to designate a drive to represent a device 96 to be accessed. Instead, a device 96 may be represented by a folder in a file path, where such file path may include certain of the parameters 98 that are to be used for operation of a device 96. A user may direct file path API 115 to create a folder under a drive that is reserved for peripheral devices, or under a folder that is already designated for this device 96, or elsewhere in computer 104. Device function execution module 118 and parameter generator 116 may query device 96 or for example a parent folder of the folder to be created, to collect features 97 and parameters 98 for operation of device 96. Parameter generator 116 may detect the parameters 98 in the existing file path, and may add new or additional parameters 98 selected by the user to the file path or to an initialization file or in the registry. The operating system may represent or display the device 96 as a directory on the designated drive, and a user may select the directory for operation of the device 96.

In some embodiments, a user may create a file that may include particular parameters 98 that may be called as part of an activation of device 96. The user may direct file path API 115 to create the file to be stored under for example a drive designated for device 96 or under another drive. Such a request may alert handler 119 within special storage device driver 114 to extract parameters 98 from the path of the created file and to provide or expose such parameters 98 to parameter generator 116. If the name of the created file includes one or more parameters 98 for device 96, such parameters 98 may be read by parameter generator 116 and checked for consistency or applicability with some or all of the other parameters 98 that may be included in the path of the file. Parameters 98 in the file name that are inconsistent with parameters 98 in the rest of the path may be replaced or dealt with in the manner set forth herein. If the name of the file does not include parameters 98 needed for operation of device 96, the default parameters may be applied, or the parameters 98 that are included in the path of the file or the parent director may be applied. In some embodiments, a combination of parameters 98 from the file name and the parent directory or file path may be applied. The parameter generator 116 may collect and save the relevant parameters 98 in the created file, so that when such file is called, the saved parameters 98 are presented to device 96.

Once a file or a folder has been created or stored under a drive that is associated with the specific operation, a user may issue a read command using file path API 115 listing such created file as the file or folder path to be read. The API handler 119 may transfer the requested file or folder path to parameter generator 116, which may extract or read the parameters 98 saved in the file and transfer such parameters 98 to converter 117 and function execution module 118 which may activate device 96 to perform for example a scan of a document in accordance with the parameters 98 that are saved and that were read from the file. Function execution module 118 may save data from the scan in a format defined by an extension (.pdf, .tif, etc.) of the file name from which the parameters 98 were read, and the scanned data may be converted to such format. In some embodiments such conversion may require access to external libraries and applications such as special optical character recognition engines or image processing libraries. Function execution module 118 may apply specialized filters or applications to the data as may have been included in the parameters 98 saved in the created file.

In some embodiments, a user may use file path API 115 to issue an open file command for a file that includes parameters 98 for device 96. API 115 may transfer the open file command to the API handler 119 which may transfer it to parameters generator 116, converter 117 and function execution module 118 which may initialize device 96 and may lock device 96 against use by others until the completion of the specific activity or functions have been assigned by the user. Once the user's functions have been complete, the user or function execution 118 activator may close the file and end the initialization of device 96.

In some embodiments, scanned data may be automatically saved on storage device 109 until a user removes it or reads it. In some embodiments a function execution module may automatically activate a default application or get from the file path the application to be activated and transfer the scanned data to the application.

In some embodiments, a user application may be operated from a remote computer, where the storage device appears as a networked device, allowing the transparent access of such storage device and its related scanner from other remote computers that are connected to the network or on the Internet or allowing a terminal-server configuration for a server application to access transparently through a network storage API scanner located at the end user terminal where in this case the user and the scanner are located at the terminal and the server application is located remotely on a local network or internet.

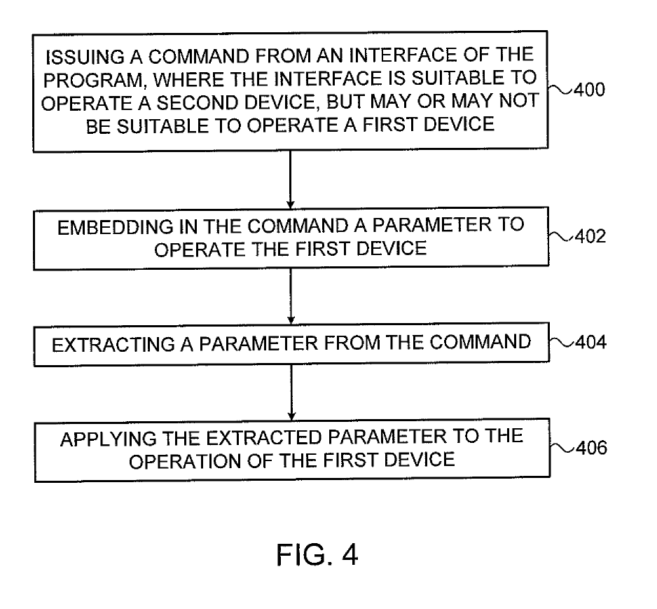

Reference is made to FIG. 4, a flow diagram of a method of operating a device from a program or application that lacks an interface for the device, in accordance with an embodiment of the invention. In block 400, a command may be issued from an interface of the program, where the interface is suitable to operate a second device, but is not typically suitable to operate a first device. In block 402, there may be embedded in the command a parameter to operate the first device. In block 404, a parameter may be extracted from the command. In block 406, the extracted parameter may be applied to the operation of the first device.

In some embodiments, a method may include querying the first device to find a parameter that is suitable for operation of the first device, and storing the found parameter in a file path associated with the first device.

In some embodiments, a method may include applying to the operation of the first device a second parameter, from among several possible parameters that may be found in a memory of a third device that is running the program.

In some embodiments, a method may include issuing a prompt for a selection by a user from among the several parameters that may be used for operation of the first device.

In some embodiments, a method may include embedding an operational parameter for a scanner in a file path, and applying the operational parameter to a scan of a document.

In some embodiments, a method may include selecting a file path from a function within the program, where the file path includes a representation of the scanner or device that is to be operated.

In some embodiments, a method may include detecting an inconsistency between a first entry in the selected file path and a second entry in the selected file path, and applying the second entry as the operational parameter for operation of the scanner, as a resolution of the inconsistency. In some embodiments, the inconsistency may include two parameters in the file path that are to be applied to the same feature of the device.

In some embodiments, a method may include storing in a file path or command a default parameter for an operation of the device.

In some embodiments, a method may include designating a drive-level entry associated with a computer that runs the program, where the drive-level entry associated with an application performs the extracting and applying.

In some embodiments, a user application may include two interfaces, such as an interface for a storage device as is typical for user applications, and an interface for a device such as a scanner, where such interface is not typically included in a user application. A user may be allowed to select from among the two interfaces that he wishes to use in order to operate the device such as a scanning device.

It will be appreciated by persons skilled in the art that embodiments of the invention are not limited by what has been particularly shown and described hereinabove. Rather the scope of at least one embodiment of the invention is defined by the claims below.

I claim:

1. A method of operating a first device from a program that includes an interface for operating a second device, comprising:
issuing a command by executing an interface of said program, said interface of said program suitable to operate said second device;
embedding in said command a parameter to operate said first device;
extracting from said command said parameter; and
applying said parameter to an operation of said first device.

2. The method as in claim 1, comprising accepting commands for an operation of said first device, wherein said embedding comprises embedding said accepted commands for an operation of said first device.

3. The method as in claim 2, comprising comparing said commands from a said program for an operation of said first device to a list of commands that are acceptable for an operation of said first device, and selecting said commands that appear on said list of commands acceptable for an operation of said device.

4. The method as in claim 1, comprising selecting command parameters required for an operation of said first device, and wherein said embedding comprises embedding said selected command parameters required for said operation of said first device

5. The method as in claim 1, comprising querying said first device for a parameter suitable for operation of said first device, and storing said parameter in a file path associated with said first device.

6. The method as in claim 1, wherein
said first device comprises a scanner;
said second device comprises a hard drive, and
said command includes a file path; and
wherein said embedding comprises embedding an operational parameter for said scanner in said file path; and
wherein said applying comprises applying said operational parameter to a scan of a document by said scanner.

7. The method as in claim 6, wherein said scanner is represented by an entry in said file path, and wherein said method comprises selecting said file path from within said program, said file path including said representation of said scanner.

8. The method as in claim 7, comprising detecting an inconsistency between a first entry in said file path and a second entry in said file path.

9. The method as in claim 8, comprising applying said second entry as said operational parameter for said scan if said inconsistency is detected.

10. The method as in claim 8, wherein said detecting said inconsistency comprises detecting that said first entry and said second entry represent parameters of a same feature of said first device.

11. The method as in claim 1, comprising storing a default parameter for an operation of said first device in said command.

12. A system comprising:
a processor;
a memory to store an application, said application including an interface suitable to operate a second device;
a first device; a second device;
wherein said processor is to execute instructions that:
process a command from said interface, said command including an embedded parameter to operate said first device;
extract from said command said parameter; and
apply said parameter to an operation of said first device.

13. The system as in claim 12, wherein said processor is to query said first device for a parameter suitable for operation of said first device, and is to store said parameter suitable for operation of said first device in a file path associated with said first device.

14. The system as in claim 12, wherein said parameter comprises a first parameter, and wherein said processor is to apply a second parameter, from among a plurality of parameters useable for an operation of said first device, to said operation of said first device, said second parameter stored in a memory of a third device running said program.

15. The system as in claim 14, wherein said processor is to issue a prompt for a selection from among said plurality of parameters useable for said operation of said first device.

16. The system as in claim 12, wherein said first device comprises a scanner, wherein said processor is to embed in a file path an operational parameter for said first device in a file path, and apply the embedded operational parameter to a scan by said scanner.

17. The system as in claim 16, wherein said scanner is represented by an entry in said file path, and wherein said processor is to select said file path from an interface associated with said application, said file path including said representation of said scanner.

18. The system as in claim 17, wherein said processor is to detect an inconsistency between a first entry in said file path and a second entry in said file path, and wherein said processor is to apply said first entry to an operation of said scanner.

19. A memory device having stored thereon instructions, that when executed by a processor result in:
operating a first device from a program, comprising:
issuing a command from an interface of a program, said interface of said program suitable to operate a second device;
embedding in said command a parameter to operate said first device;
extracting from said command said parameter; and
applying said parameter to an operation of said first device.

20. The memory device as in claim 19, wherein:
said first device comprises a scanner;
said second device comprises a hard drive; and
said command includes a file path; and
wherein said embedding comprises embedding an operational parameter for said scanner in said file path; and
wherein said applying comprises applying said operational parameter to a scan of a document by said scanner.
